(19) United States
(12) Patent Application Publication
(10) Pub. No.: US 2004/0084371 A1
(43) Pub. Date: May 6, 2004

(54) Dialysis system and method for automatically priming a dialyzer

(76) Inventors: Benjamin A. Kellam, Clearwater, FL (US); Scott Keeling, Holiday, FL (US); Li Pan, Tampa, FL (US)

Correspondence Address: BAXTER HEALTHCARE CORPORATION, RENAL DIVISION, 1 BAXTER PARKWAY, DF3-3E, DEERFIELD, IL, 60015, US

(21) Appl. No.: 10/288,758

(22) Filed: Nov. 6, 2002

(51) Int. Cl. B01D 61/00

(52) U.S. Cl. 210/646; 210/321.71

(57) ABSTRACT

A dialysis system and a method for automatically priming a dialyzer are provided. The priming of the dialyzer is accomplished in two steps; namely, the use of a blood pump to prime a dialyzer followed by the use of the blood pump and a dialysate pump to prime the dialyzer. The dialysis system filters a fluid through an extracorporeal circuit, a balanced flow loop and a dialysate loop which is connected to the dialyzer. The dialysis system and method may prevent air or air bubbles from entering the blood stream of a patient during dialysmis. Moreover, the dialysis system may be, for example, a hemodialysis or peritoneal dialysis system.

### BACKGROUND OF THE INVENTION

The present invention generally relates to a dialysis system and a method for automatically priming a dialyzer. More specifically, the present invention relates to a system and a method for sequencing valves and/or pumps to prime the dialyzer. The priming of the dialyzer is accomplished in two steps; namely, the use of a blood pump to prime fibers of the dialyzer followed by the use of the blood pump as well as a dialysate pump to prime a housing of the dialyzer. The dialysis system and method may be used for hemodialysis or peritoneal dialysis.

Normally, kidneys of a person cleanse blood within the person. Often, however, kidneys fail or otherwise do not properly function in a person which is generally referred to as “renal disease.” As a result, a dialyzer may be implemented to cleanse the blood of the person. Essentially, the dialyzer replaces the natural function of the kidney. Because the person may need to undergo dialysis on a regular basis, prolonged use of the dialyzer to implement the dialysis process may be costly in both time and money.

Generally, two methods are available for performing dialysis, namely, peritoneal dialysis and hemodialysis. Peritoneal dialysis is a technique in which the body tissue of the patient acts as a filter for blood-borne toxins and/or excess water. The removal of certain elements, for example, blood-borne toxins and/or excess water, from the blood in dialysis is accomplished by virtue of the differences in rates of their diffusion through a semipermeable membrane. Typically, the blood remains within the semipermeable membrane of a dialyzer while a dialysate solution remains outside the semipermeable membrane, but within the dialyzer. The blood-borne toxins and/or excess water then diffuse and/or are forced across the semipermeable membrane by a pressure gradient into the dialysate and are ultimately discarded.

Hemodialysis is performed similarly to peritoneal dialysis, except the blood is cleaned outside of the body of the patient by a dialyzer. Furthermore, in hemodialysis, a needle is inserted into a vascular access port positioned on the patient. Blood is then withdrawn from the patient and sent to the dialyzer. Within the dialyzer, a filter substitutes for the process of a properly functioning kidney. After filtration, the blood is returned to the patient.

Generally, a patient requires three dialysis sessions a week. Each session requires approximately three hours to complete. If the kidneys are damaged, the patient may undergo dialysis until the patient receives a kidney transplant.

A major problem with dialysis is that bubbles often form in the dialyzer due to inadequate removal of air from the dialyzer prior to use by the patient. If air and/or bubbles are present in the dialyzer, the patient may be injured or otherwise adversely affected. To remove the air and/or bubbles, a health-care provider or other person “primes” the dialyzer prior to use.

In known priming techniques, a nurse, for example, manipulates and/or strikes the dialyzer to remove the air and/or bubbles. In addition, a blood line, for example, an extracorporeal circuit, from the patient to the dialyzer is also primed by the nurse. As a result, the patient is often required to spend considerable energy to prime the dialyzer by removing air and/or bubbles from the blood lines prior to the dialysis process. Further, previous priming dialysis devices and techniques are both inefficient and/or time consuming.

A need, therefore, exists for a dialysis system and a method for priming a dialyzer which overcome deficiencies of known devices, systems and methods for priming a dialyzer. Additionally, a need exists for a dialysis system and a method for automatically priming a dialyzer.

### SUMMARY OF THE INVENTION

The present invention provides a dialysis system and a method for automatically priming a dialyzer. More specifically, the present invention relates to a system and a method for controlling a sequence of valves and/or pumps to prime the dialyzer. The priming of the dialyzer is accomplished in two steps; namely, the use of a blood pump to fill the dialyzer followed by the use of the blood pump and a dialysate pump to prime the dialyzer.

To this end, in an embodiment of the present invention, a method is provided for priming a dialyzer within a dialysis system wherein the dialyzer has an interior and further has fibers within the interior wherein the fibers have walls and an interior. The method has the steps of: pumping a liquid at a first pressure into the fibers; pumping the liquid at a second pressure into the fibers wherein the second pressure is not equal to the first pressure; pumping the liquid at the first pressure through the dialyzer in a first direction wherein the liquid is within the dialyzer exterior to the fibers; and pumping the liquid at the second pressure through the dialyzer.

In an embodiment, the first pressure is greater than the second pressure.

In an embodiment, the first pressure is less than the second pressure.

In an embodiment, the method further has the step of: recirculating the liquid within the dialyzer at the second pressure.

In an embodiment, the method further has the steps of: recirculating the liquid through the fibers; and simultaneously pumping the second liquid within the dialyzer exterior to the fibers.

In an embodiment, the method further has the steps of: forcing the liquid within the fibers through the walls of the fibers.

In an embodiment, the method further has the step of: forcing the fluid through the dialyzer in a second direction which is opposite to the first direction.

In another embodiment of the present invention, a method is provided for priming a dialyzer within a dialysis system. The method has the steps of: providing a first pump which provides a number of high pressure strokes and a number of low pressure strokes wherein the high pressure stroke is at a pressure greater than a pressure of the low pressure stroke; providing a second pump which provides a number of high pressure strokes and a number of low pressure strokes wherein the high pressure stroke is at a pressure greater than a pressure of the low pressure stroke; filling the dialyzer with a fluid with the low pressure stroke from the first pump; applying the high pressure stroke from the first pump to force the fluid through the dialyzer; and filling the dialyzer with the fluid using the low pressure stroke from the second pump wherein the fluid moves in a first direction.

In an embodiment, the number of high pressure strokes provided by the first pump is greater than the number of low pressure strokes provided by the first pump.

In an embodiment, the number of high pressure strokes provided by the second pump is less than the number of low pressure strokes provided by the second pump.

In an embodiment, the method further has the steps of: recirculating the fluid in the dialyzer with the high pressure stroke from the first pump; and simultaneously filling the dialyzer with the fluid with the second pump.

In an embodiment, the method further has the steps of: recirculating the fluid in the dialyzer with the high pressure stroke from the first pump; and simultaneously directing the fluid into the dialyzer using the high pressure stroke from the second pump.

In an embodiment, the method further has the steps of: recirculating the fluid in the dialyzer with the high pressure stroke from the first pump; and simultaneously directing the fluid to the dialyzer using the second pump.

In an embodiment, the method further has the steps of: recirculating the fluid in the dialyzer with the high pressure stroke from the first pump; and simultaneously forcing the fluid within the dialyzer in a second direction opposite to the first direction.

In an embodiment, the method further has the step of: automatically controlling the pumping of the first liquid and the pumping of the second liquid.

In another embodiment of the present invention, a system is provided for priming a dialyzer having an interior having fibers in the interior. The system has a first pump which provides a high pressure stroke and a low pressure stroke wherein the high pressure stroke is greater than the low pressure stroke wherein the first pump directs a fluid into the dialyzer at the low pressure stroke and directs the fluid through the dialyzer at the high pressure stroke. The system also has a second pump which provides a high pressure stroke and a low pressure stroke wherein the high pressure stroke is greater than the low pressure stroke and wherein the second pump directs the fluid into the dialyzer at the low pressure stroke and directs the fluid through the dialyzer at the high pressure stroke. In addition, the system has a computer in communication with the first pump and the second pump wherein the computer controls the pumping of the fluid.

In an embodiment, the first pump directs the fluid with the high pressure stroke after directing the fluid with the low pressure stroke.

In an embodiment, the second pump directs the fluid with the low pressure stroke after directing the fluid with the high pressure stroke.

In an embodiment, the system has a valve in communication with the first pump and the dialyzer wherein the computer controls the valve.

In an embodiment, the second pump recirculates the fluid into the dialyzer.

In another embodiment of the present invention, a method is provided for priming a dialyzer within a dialysis system wherein the dialyzer has an interior and further has fibers within the interior wherein the fibers have walls and an interior. The method has the steps of: pumping a liquid at a first flowrate into the fibers; pumping the liquid at a second flowrate into the fibers wherein the second flowrate is not equal to the first flowrate; pumping the liquid at the first flowrate through the dialyzer in a first direction wherein the liquid is within the dialyzer exterior to the fibers; and pumping the liquid at the second flowrate through the dialyzer.

In an embodiment, the first flowrate is greater than the second flowrate.

In an embodiment, the first flowrate is less than the second flowrate.

In an embodiment, the method further has the step of: recirculating the liquid within the dialyzer at the second flowrate.

In an embodiment, the method further has the step of: forcing the liquid within the fibers through the walls of the fibers.

It is, therefore, an advantage of the present invention to provide a dialysis system and a method for automatically priming a dialyzer.

Another advantage of the present invention is to provide a dialysis system and a method for automatically priming a dialyzer wherein the dialysis system has a first fluid loop and a second fluid loop within a dialysate circuit.

Yet another advantage of the present invention is to provide a dialysis system and a method for automatically priming a dialyzer which does not require manipulation or interaction by a person.

A still further advantage of the present invention is to provide a dialysis system and a method for automatically priming a dialyzer wherein the dialyzer removes toxins from the blood.

And, another advantage of the present invention is to provide a dialysis system and a method for automatically priming a dialyzer wherein the dialysis system is controlled by a computer.

Another advantage of the present invention is to provide a dialysis system and a method for automatically priming a dialyzer wherein the dialysis system has a weir for venting air.

Yet another advantage of the present invention is to provide a dialysis system and a method for automatically priming a dialyzer wherein air is removed from the dialysis system.

Moreover, an advantage of the present invention is to provide a dialysis system and a method for automatically priming a dialyzer wherein the dialysis system reverses a flow of fluid within a dialyzer.

Additional features and advantages of the present invention are described in, and will be apparent from, the detailed description of the presently preferred embodiments and from the drawings.

### BRIEF DESCRIPTION OF THE DRAWINGS

FIG. 1 illustrates a diagram of a peritoneal dialysis system.

FIG. 2 illustrates a flowchart of the steps for automatically priming a dialyzer.

FIG. 3 illustrates a diagram of a hemodialysis system.

### DETAILED DESCRIPTION OF THE PRESENTLY PREFERRED EMBODIMENTS

The present invention generally relates to a dialysis system and a method for automatically priming a dialyzer. Moreover, the present invention provides a system and a method for sequencing valves and/or pumps to prime the dialyzer. Further, the present invention provides a dialysis system having a dialysate circuit having a first fluid loop and a second fluid loop. The priming of the dialyzer is accomplished in two steps; namely, the use of a blood pump to fill a dialyzer followed by the use of the blood pump and a dialysate pump to prime the dialyzer. The dialysis system and method may be utilized in peritoneal dialysis or hemodialysis.

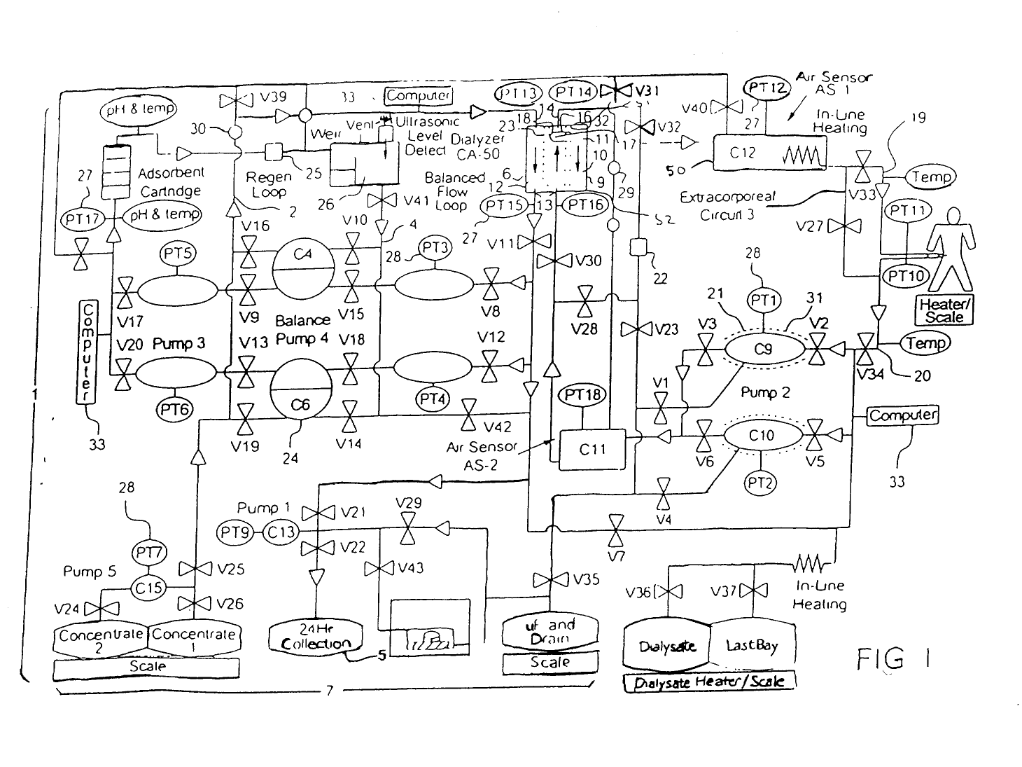

Referring now to the drawings wherein like numerals refer to like parts, FIG. 1 generally illustrates a diagram of a peritoneal dialysis system 1 which may be primed prior to dialysis. The peritoneal dialysis system 1 may have a dialysate loop 2, an extracorporeal circuit 3, a balanced flow loop 4 and/or a collection container 5.

The dialysate loop 2 of the peritoneal dialysis system 1 may control, for example, temperature and/or pH of a fluid. The extracorporeal circuit 3 of the peritoneal dialysis system 1 may circulate, for example, blood into and/or out of the patient. The balanced flow loop 4 of the peritoneal dialysis system 1 may, for example, connect the dialysate loop 2 to the extracorporeal circuit 3. A patient may prime the peritoneal dialysis system 1 and/or the extracorporeal circuit 3 by removing air and/or bubbles from the peritoneal dialysis system 1 and/or the extracorporeal circuit 3 prior to dialysis.

The dialysate loop 2, the extracorporeal circuit 3 and/or the balanced flow loop 4 may each be connected to a dialyzer 6. More specifically, the dialyzer 6 may be the area of the peritoneal dialysis system 1 in which the fluid exchange takes place. Further, the dialysate loop 2 and the balanced flow loop 4 may have a dialysate circuit 7.

The dialyzer 6 of the peritoneal dialysis system 1 may have a shell 9, a top side 51 and/or a bottom side 52. Further, the shell 9 may have an interior 10 capable of holding, for example, a fluid. The dialyzer 6 may be divided into, for example, a primary side 11 and/or a secondary side 12. The primary side 11 of the dialyzer 6 may refer to the side of the dialyzer 6 in which, for example, the blood of the patient is present. The secondary side 12 of the dialyzer 6 may refer to the side of the dialyzer 6 in which, for example, a dialysate solution is present. The primary side 11 and/or the secondary side 12 of the dialyzer 6 may be primed prior to dialysis.

The dialyzer 6 may further have an inlet port 13 and/or an outlet port 14. The inlet port 13 may allow, for example, the fluid to enter the dialyzer 6. The outlet port 14 may allow, for example, the fluid to exit the dialyzer 6. Still further, the dialyzer 6 may have a pump chamber 15 which may, for example, control the flow of the fluid within the dialyzer 6. When the peritoneal dialysis system 1 is used to prime the dialyzer 6, the inlet port 13, the outlet port 14 and/or the pump chamber 15 may be sequentially controlled.

The interior 10 of the dialyzer 6 may contain fibers 16 wherein each of the fibers 16 may have a pore 17. Further, the fibers 16 may have a top 18 which, for example, traps air. The pore 17 of the fibers 16 may be semipermeable and may allow, for example, fluids, toxins, water or the like, to diffuse from, for example, the primary side 11 of the dialyzer 6 to the secondary side 12 of the dialyzer 6.

Toxins, fluids and/or excess water in the blood or dialysate may diffuse across the semipermeable fibers 16 and may exit the blood via the secondary side 12 of the dialyzer 6. The blood or dialysate may then be returned to the patient. The fibers 16 of the dialyzer 6 may, for example, increase surface area for diffusion of the blood or dialysate.

The extracorporeal circuit 3 may connect the patient to the dialyzer 6. More specifically, the extracorporeal circuit 3 may have an arterial blood line 19 and/or a venous blood line 20 which may connect the patient to the dialyzer 6. The extracorporeal circuit 3 may also have a blood pump 21 for pumping fluid to or from the dialyzer 6. The blood pump may be, for example, Pump 2. Further, the blood pump 21 may be, for example, a dialysate pump, such as, for example, Pump 3 or Pump 4 (as shown in FIG. 1). Further, a patient clamp 22 may be located in the extracorporeal circuit 3. Still further, an air sensor 50 may be located within the extracorporeal circuit 3. The air sensor 50 may, for example, detect the presence of air within the peritoneal dialysis system 1. Air and/or bubbles may be present in the extracorporeal circuit 3 prior to the dialysis process. As a result, the patient or other health professional may need to prime the extracorporeal circuit 3 by removing the air and/or bubbles.

The dialysate circuit 7 may have the dialysate loop 2 and/or the balanced flow loop 4. Moreover, the dialysate loop 2 may circulate a dialysate solution through the dialyzer 6. The dialysate loop 2 may also have a dialysate pump 24 which may, for example, pump the fluid to or from the dialyzer 6. The dialysate pump 24 may be, for example, Pump 2. Further, the dialysate pump 24 may be, for example, Pump 3 or Pump 4 (also referred to as a dialysate pump) as illustrated in FIG. 1. Further, a dialysate clamp 25 may be located, for example, within the dialysate loop 2.

The balanced flow loop 4 may be located within, for example, the dialysate circuit 7. A weir 26 may connect the dialysate loop 2 with, for example, the balanced flow loop 4. The weir 26 may control, for example, the level of fluid in the dialysate circuit 7. Further, the weir 26 may allow the fluid to vent and/or may divert the direction of the fluid in the dialysate circuit 7. More specifically, the weir 26 may have a vent 44 which may, for example, control the flow of the fluid in the dialysate circuit 7.

The extracorporeal circuit 3, the dialysate loop 2 and the balanced flow loop 4 may each have an invasive pressure transducer 27 and/or a non-invasive pressure transducer 28. The invasive pressure transducer 27 and/or the non-invasive pressure transducer 28 may, for example, control the pressure of the fluid within the peritoneal dialysis system 1. Further, the extracorporeal circuit 3, the balanced flow loop 4 and the dialysate loop 2 may each have a water-level sensor 29 which may, for example, control the amount of water in the peritoneal dialysis system 1. Still further, a chemical sensor 30 may be attached, for example, to the dialysate loop 2, and a C-Prox volume sensor 31 may be located within, for example, the extracorporeal circuit 3. Furthermore, the pH of the blood and/or other fluid may be controlled within the dialyzer 6.

A computer 33 may be connected to, for example, the dialysate loop 2, the extracorporeal circuit 3 and/or the balanced flow loop 4. In the alternative, separate computers 33 may each be separately connected to, for example, the dialysate loop 2, the extracorporeal circuit 3 and/or the balanced flow loop 4. The computer 33 may, for example, control the automatic priming of the peritoneal dialysis system 1 by controlling the operation of, for example, the dialysate pump 24, a valve 32 and/or a port 13. The computer 33 may also control, for example, the direction and/or pressure of the fluid within the peritoneal dialysis system 1.

In the first portion of the dialysis process, the blood pump 21, also referred to as Pump 2 in FIG. 1, may be utilized. In the second portion of the dialysis process the blood pump 21 and the dilaysate pump 24, also referred to as Pump 3 or Pump 4, may be utilized to complete the dialysis process.

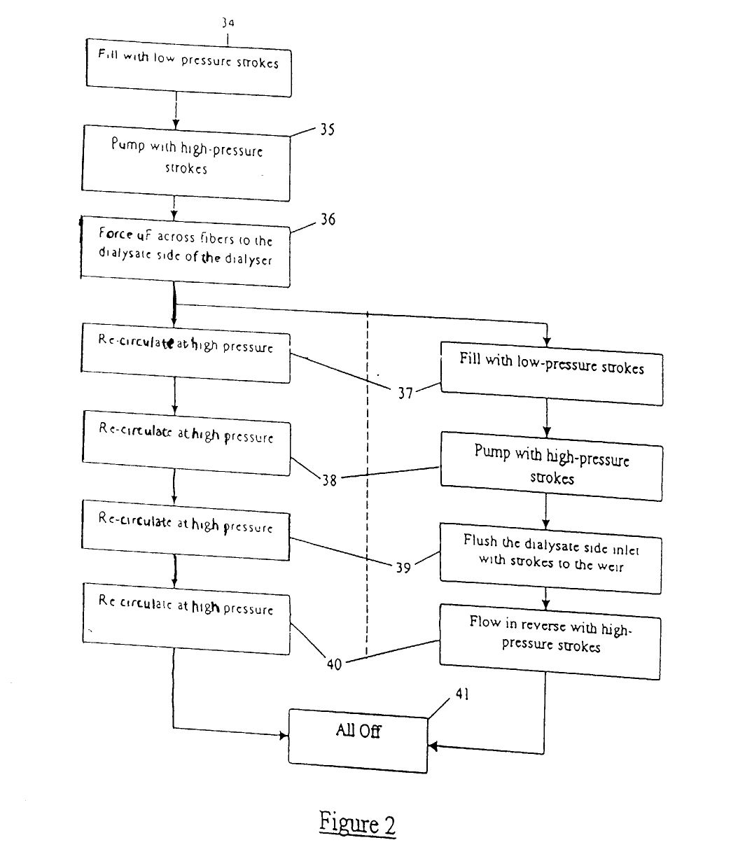

FIG. 2 is a flowchart illustrating steps for the automatic priming of the dialyzer 6. During priming of the dialyzer 6, the primary side 11 of the dialyzer 6 may be filled with fluid via pump strokes, as shown in step 34. The pump strokes may be between, for example, 1.0 to 1.5 psi, which may correlate to a first flowrate of the fluid through the dialyzer 6. The pump strokes may, for example, force the fluid through a majority of the fibers 16 within the dialyzer 6. The pump strokes may also prevent, for example, foam from developing on the inlet port 13 of the fibers 16.

Further, during priming of the peritoneal dialysis system 1, high pressure pump strokes may force the fluid through the primary side 11 of the dialyzer 6, as shown in step 35. The high pressure strokes may correlate to a second flowrate of the fluid thorough the dialyzer 6. The high pressure pump strokes may be between, for example, 3.0 and 5.0 psi. The high pressure pump strokes may, for example, remove air and/or bubbles trapped in the primary side 11 of the dialyzer 6. Further, the force of the fluid may remove air and/or bubbles that may attach to, for example, the fibers 16.

Additionally, during priming, fluid may be forced through the fibers 16 from the primary side 11 of the dialyzer 6 to the secondary side 12 of the dialyzer 6, as shown at step 36. To this end, the outlet valve 32 on the primary side 11 of the dialyzer 6 may be closed, and fluid may be pumped at a high pressure through the fibers 16 in the dialyzer 6. The fluid may be pumped at a pressure of, for example, 5.0 psi. The fluid flowing through the fibers 16 in the dialyzer 6 may remove air and/or bubbles trapped in the interior 10 of the dialyzer 6. Further, the fluid may remove air and/or bubbles trapped in the pores 17 of the fibers 16. The priming of the secondary side 12 of the dialyzer 6 may also begin as shown at step 36.

The secondary side 12 of the dialyzer 6 may be filled with fluid by low pressure pump strokes, as shown at step 37. More specifically, the secondary side 12 of the dialyzer 6 may be filled with, for example, a dialysate solution. The low pressure pump strokes may be between, for example, 1.0 and 1.5 psi. Further, the secondary side 12 of the dialyzer 6 may be filled with fluid at the same time the fluid is recirculated in the primary side 11 of the dialyzer 6 with fluid from high pressure pump strokes.

During priming, pump strokes may force fluid to fill the shell 9 of the secondary side 12 of the dialyzer 6. The pump strokes may be pumped at, for example, a low pressure, or flowrate, to prevent the air in the secondary side 12 of the dialyzer 6 from forming bubbles. The fluid may also be recirculated in the primary side 11 of the dialyzer 6 to remove air and/or bubbles trapped in the fibers 16. Moreover, the air and/or bubbles may be removed by the force of the fluid in the primary side 11 of the dialyzer 6. Further, the fluid may be recirculated in the primary side 11 of the dialyzer 6 to remove air and/or bubbles trapped in, for example, a fiber outlet 23.

As shown at step 38 of the priming of the peritoneal dialysis system 1, high pressure pump strokes may force the fluid through the secondary side 12 of the dialyzer at a high flowrate 6 while the fluid is recirculated in the primary side 11. The high pressure pump strokes may force air trapped in the secondary side 12 of the dialyzer 6 to be removed from the dialyzer 6. Further, the pump strokes may force air trapped at, for example, the outlet port 14 to be removed from the dialyzer 6. Still further, fluid recirculated in the primary side 11 of the dialyzer 6 may force air trapped in, for example, the fibers 16 and/or the fiber outlet 23 to be removed from the dialyzer 6.

The inlet port 13 on the secondary side 12 of the dialyzer 6 may be filled with, for example, fluid via medium pump strokes to the weir 26, as shown at step 39. At the same time, the fluid in the primary side 11 of the dialyzer 6 may be recirculated with, for example, high pressure pump strokes. Further, the air between the secondary side 12 of the dialyzer 6 and the pump chamber 15 may be removed. After the air between the secondary side 12 of the dialyzer 6 and the pump chamber 15 is removed, the direction of the fluid may be reversed. The fluid may then be, for example, diverted to the weir 26 and then vented. Further, the recirculated fluid in the primary side 11 of the dialyzer 6 may force air trapped in, for example, the fibers 16 and/or the fiber outlet 23 to be removed from the dialyzer 6.

Further, during priming of the peritoneal dialysis system 1, pump strokes in the reverse direction may, for example, force fluid through the secondary side 12 of the dialyzer 6, as shown at step 40. Further, the fluid in the primary side 11 of the dialyzer 6 may be recirculated with, for example, high pressure pump strokes. The pump strokes may, for example, force fluid to remove air trapped in the inlet port 13 of the secondary side 12 of the dialyzer 6. Further, the fluid recirculated in the primary side 11 of the dialyzer 6 may remove air and/or bubbles trapped in the fibers 16 and/or the fiber outlet 23.

Finally, the computer 33 may be programmed to shut off, for example, the dialysate pump 24, the valve 32 and/or the port 13. Furthermore, the computer 33 may be programmed to stop the dialysate pump 24, the valve 32 and/or the port 13 after the dialyzer 6 is primed, as shown in step 41.

As stated above, a peritoneal dialysis system 1 and a method for automatically priming a dialyzer 6 are provided in the present invention. The priming of the peritoneal dialysis system 1 may be accomplished by, for example, the computer 33 controlling the dialysate pump 24, the valve 32 and/or the port 13 of the two loops of the dialysate circuit. More specifically, the computer 33 may control the dialysate pump 24, the valve 32 and/or the port 13 to, for example, prevent air or air bubbles from entering the blood stream of the patient during dialysis.

The two loops of the dialysate circuit may control, for example, the temperature, the flow and/or the pH of the blood and/or other fluid. Further, the two loops of the dialysate circuit may prevent toxins and/or other harmful substances from returning into the blood circulation of the patient.

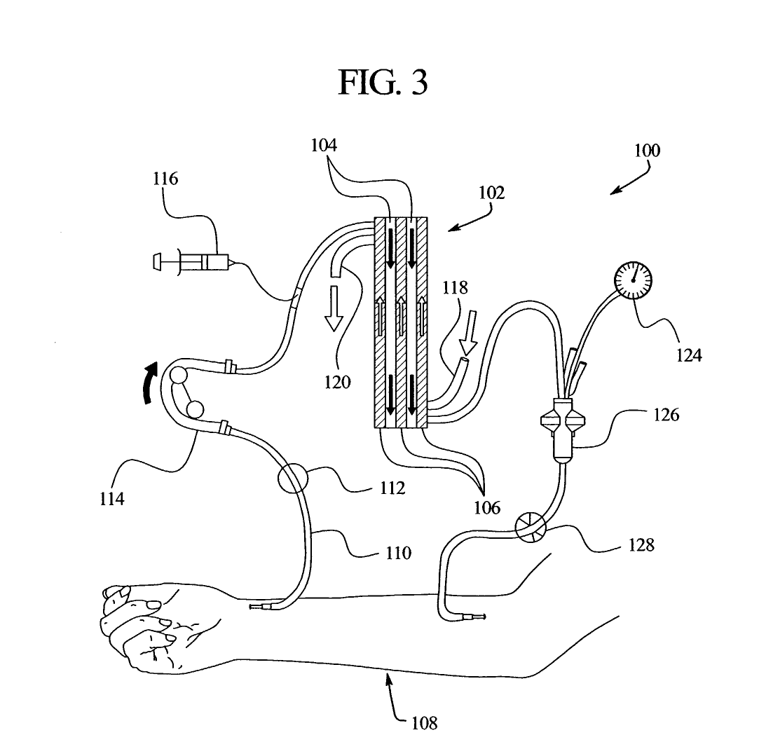

FIG. 3 illustrates a system 100 which may be used for hemodialysis. The system 100 may have a dialyzer 102, illustrated in cross-section, which may have fibers 104. Fluid, such as, for example, blood may travel through the fibers 104. In addition, a fluid, such as, for example, dialysate, may travel within the dialyzer 102, exterior to the fibers 104 on a secondary side 106 of the dialyzer 102. The dialysate may travel in a direction opposite to a direction of a flow of blood through the fibers 104.

The dialyzer 102 may be connected to a patient 108 via a first tube 110 which may transport blood from the patient 108 to the dialyzer 102. An arterial pressure monitor 112 may be positioned along the tube 110. In addition, a blood pump 114 may be positioned along the tube 110 to assist in transporting blood from the patient 108 to the dialyzer 102. A second pump 116 may also be positioned on the tube 110 between the blood pump 114 and the dialyzer 102. Preferably, the pump 116 may be a heparin pump.

A tube 118 may be provided for delivering dialysate to the dialyzer 102. The dialysate may be delivered by a dialysate pump (not shown). A second tube 120 may be connected to the dialyzer 102 and may remove fluids from the secondary side 106 of the dialyzer 102. A tube 122 may be connected to the dialyzer 102 to remove fluids from the fibers 104 of the dialyzer 102. A venous pressure monitor 124 may be positioned along the tube 122. In addition, an air detector 126 may be positioned along the tube 122. A clamp 128 may be positioned along the tube 122 between the air detector 126 and the patient 108.

The dialyzer 102 of the system 100 may be primed using the blood pump 114 and the dialysate pump. To this end, the blood pump 114 may direct a fluid toward the dialyzer 102 at a low pressure stroke, or low flowrate. Next, the blood pump 114 may force the fluid through the fibers 104 using a high pressure stroke, or high flowrate. Next, the clamp 128 may prevent the fluid from exiting the dialyzer 102 through the fibers 104. The fluid may then be forced through the fibers 104 into the secondary side 106 by being pumped with a high pressure stroke from the blood pump 114.

Next, the dialysate pump may direct a fluid to the secondary side 106 of the dialyzer 102 with a low pressure stroke. Simultaneously, the blood pump 114 may direct the fluid through the fibers 104 with a high pressure stroke. The dialysate pump may then force the fluid through the secondary side 106 with a high pressure stroke. Simultaneously, the blood pump 114 may recirculate the fluid through the fibers 104.

Air within the dialyzer 102 may then be removed and detected by the air detector 126. Upon removal of the air from the dialyzer 102, a direction of flow for the fluid through the dialyzer 102 may be reversed along the secondary side 106. Simultaneously, the blood pump 114 may recirculate the fluid through the fibers 104 using a high pressure stroke, or high flowrate. A computer (not shown) in communication with the blood pump 114 and/or dialysate pump may be programmed to automatically direct fluid to the dialyzer 102. The computer may also be programmed to operate the clamp 128.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A method for priming a dialyzer within a dialysis system wherein the dialyzer has an interior and further has fibers within the interior wherein the fibers have walls and an interior, the method comprising the steps of:
pumping a liquid at a first pressure into the fibers;
pumping the liquid at a second pressure into the fibers wherein the second pressure is not equal to the first pressure;
pumping the liquid at the first pressure through the dialyzer in a first direction wherein the liquid is within the dialyzer exterior to the fibers; and
pumping the liquid at the second pressure through the dialyzer.

2. The method of claim 1 wherein the first pressure is greater than the second pressure.

3. The method of claim 1 wherein the first pressure is less than the second pressure.

4. The method of claim 1 further comprising the step of:
recirculating the liquid within the dialyzer at the second pressure.

5. The method of claim 1 further comprising the step of:
recirculating the liquid through the fibers; and
simultaneously pumping the liquid within the dialyzer exterior to the fibers.

6. The method of claim 1 further comprising the step of:
forcing the liquid within the fibers through the walls of the fibers.

7. The method of claim 1 further comprising the step of:
forcing the fluid through the dialyzer in a second direction which is opposite to the first direction.

8. A method for priming a dialyzer within a dialysis system, the method comprising the steps of:
providing a first pump which provides a number of high pressure strokes and a number of low pressure strokes wherein the high pressure stroke is at a pressure greater than a pressure of the low pressure stroke;
providing a second pump which provides a number of high pressure strokes and a number of low pressure strokes wherein the high pressure stroke is at a pressure greater than a pressure of the low pressure stroke;
filling the dialyzer with a fluid with the low pressure stroke from the first pump;
applying the high pressure stroke from the first pump to force the fluid through the dialysis apparatus; and
filling the dialyzer with the fluid using the low pressure stroke from the second pump wherein the fluid moves in a first direction.

9. The method of claim 8 wherein the number of high pressure strokes provided by the first pump is greater than the number of low pressure strokes provided by the first pump.

10. The method of claim 8 wherein the number of high pressure strokes provided by the second pump is less than the number of low pressure strokes provided by the second pump.

11. The method of claim 8 further comprising the step of:
recirculating the fluid in the dialyzer with the high pressure stroke from the first pump; and
simultaneously filling the dialyzer with the fluid with the second pump.

12. The method of claim 8 further comprising the step of:
recirculating the fluid in the dialyzer with the high pressure stroke from the first pump; and
simultaneously directing the fluid into the dialyzer using the high pressure stroke from the second pump.

13. The method of claim 8 further comprising the step of:
recirculating the fluid in the dialyzer with the high pressure stroke from the first pump; and
simultaneously directing the fluid to the dialyzer using the second pump.

14. The method of claim 8 further comprising the step of:
recirculating the fluid in the dialyzer with the high pressure stroke from the first pump; and
simultaneously forcing the fluid within the dialyzer in a second direction opposite to the first direction.

15. The method of claim 8 further comprising the step of:
automatically controlling the pumping of the first liquid and the pumping of the second liquid.

16. A system for priming a dialyzer having an interior having fibers in the interior, the system comprising:
a first pump which provides a high pressure stroke and a low pressure stroke wherein the high pressure stroke is greater than the low pressure stroke wherein the first pump directs a fluid into the dialyzer at the low pressure stroke and directs the fluid through the dialyzer at the high pressure stroke;
a second pump which provides a high pressure stroke and a low pressure stroke wherein the high pressure stroke is greater than the low pressure stroke and wherein the second pump directs the fluid into the dialyzer at the low pressure stroke and directs the fluid through the dialyzer at the high pressure stroke; and
a computer in communication with the first pump and the second pump wherein the computer controls the pumping of the fluid.

17. The system of claim 16 wherein the first pump directs the fluid with the high pressure stroke after directing the fluid with the low pressure stroke.

18. The system of claim 16 wherein the second pump directs the fluid with the low pressure stroke after directing the fluid with the high pressure stroke.

19. The system of claim 16 further comprising:
a valve in communication with the first pump and the dialyzer wherein the computer controls the valve.

20. The system of claim 16 wherein the second pump recirculates the fluid into the dialyzer.

21. The system of claim 16 wherein the dialyzer is used in a hemodialysis system.

22. The system of claim 16 wherein the dialyzer is used in a peritoneal dialysis system.

23. A method for priming a dialyzer within a dialysis system wherein the dialyzer has an interior and further has fibers within the interior wherein the fibers have walls and an interior, the method comprising the steps of:
pumping a liquid at a first flowrate into the fibers;
pumping the liquid at a second flowrate into the fibers wherein the second flowrate is not equal to the first flowrate;
pumping the liquid at the first flowrate through the dialyzer in a first direction wherein the liquid is within the dialyzer exterior to the fibers; and
pumping the liquid at the second flowrate through the dialyzer.

24. The method of claim 23 wherein the first flowrate is greater than the second flowrate.

25. The method of claim 23 wherein the first flowrate is less than the second flowrate.

26. The method of claim 23 further comprising the step of:
recirculating the liquid within the dialyzer at the second flowrate.

27. The method of claim 23 further comprising the step of:
forcing the liquid within the fibers through the walls of the fibers.
